(19) United States
(12) Patent Application Publication
(10) Pub. No.: US 2015/0200555 A1
(43) Pub. Date: Jul. 16, 2015

(54) APPARATUS FOR CHARGING A LARGE NUMBER OF ELECTRONIC DEVICES

(71) Applicant: DAE HAN SPECIAL METAL IND CO., LTD., Incheon (KR)

(72) Inventor: Joon-Bum AN, Bucheon-si (KR)

(21) Appl. No.: 14/302,673

(22) Filed: Jun. 12, 2014

(30) Foreign Application Priority Data
Jan. 15, 2014 (KR) 10-2014-0005005

(51) Int. Cl. H02J 7/00

(52) U.S. Cl. CPC H02J 7/0044; H02J 7/0027; H02J 7/0052

(57) ABSTRACT

Provided is an apparatus for charging a large number of electronic devices, the apparatus including: a body that provides a predetermined internal space; a door that is configured at a front side of the body and opens/closes a front portion of the body; a cradle that is disposed in the body and provides a plurality of accommodation spaces so that electronic devices can be accommodated in the plurality of accommodation spaces; and a charging connector that is configured at the cradle so as to correspond to the plurality of accommodation spaces of the cradle, that comes into non-insertion contact with a charging port of each of the electronic devices when the electronic devices are accommodated in the accommodation spaces and that supplies charging power from a power supply unit.

### CROSS-REFERENCE TO RELATED PATENT APPLICATION

This application claims the benefit of Korean Patent Application No. 10-2014-0005005, filed on Jan. 15, 2014, in the Korean Intellectual Property Office, the disclosure of which is incorporated herein in its entirety by reference.

### BACKGROUND OF THE INVENTION

1. Field of the Invention

The present invention relates to an apparatus for charging a large number of electronic devices, and more particularly, to an apparatus for charging a large number of electronic devices in which, when the large number of electronic devices, such as tablet personal computers (PCs), are kept in a cradle, a charging port of each of the electronic devices comes into non-insertion contact with a charging connector configured at the cradle so that the electronic devices can be conveniently kept and charged.

2. Description of the Related Art

In general, electronic devices, such as tablet PCs, are a kind of mobile electronic devices, have a shape of a plate, can be manipulated by a user's finger or touch pen, can make telecommunication and near field communication and can be conveniently used and have very excellent portability.

In these days, electronic devices, such as tablet PCs, have been widely used in a variety of industrial fields as well as by individuals. In particular, since these electronic devices, such as tablet PCs, are suitable for performing interactive education using smart learning materials in the field of teaching, they are very usefully used. Also, these electronic devices, such as tablet PCs, are used for purposes of exhibition, publicrelations (PR), and information transmission in events of service business places, such as banks, hospitals, and shops, public institutions, and enterprises, or these electronic devices, such as tablet PCs, can be used as marketing instruments.

These electronic devices, such as tablet PCs, are driven by power of batteries that are built therein when they are moved. Charging apparatuses that convert common power into direct current (DC) power and supply converted power to batteries, are mainly used to charge batteries.

Since it is difficult to perform a keeping or charging operation on a large number of tablet PCs in a school, a hospital, and an enterprise in which a large number of electronic devices, such as tablet PCs, are used, a charging apparatus that is capable of conveniently charging or keeping a large number of tablet PCs, is disclosed in Korean Patent Registration No. 10-1287123.

In a conventional charging apparatus, power is supplied to a charging port of the electronic device from a charging connector of a power supply unit in a state in which a plurality of shelves are configured in an internal space of a body having a rectangular box shape and the electronic devices are respectively accommodated in the plurality of shelves.

However, the conventional charging apparatus is in a chargeable state only when a front door of a body is opened, the electronic devices are accommodated in the shelves of the body and then the charging connector of the power supply unit physically comes into insertion contact with the charging port of the electronic device through a manager's operation. Thus, a charging procedure is very complicated, and it takes much time to keep and charge a large number of electronic devices.

### SUMMARY OF THE INVENTION

The present invention provides an apparatus for charging a large number of electronic devices in which, when the large number of electronic devices are kept in a cradle, a charging port of each of the electronic devices comes into non-insertion contact with a charging connector configured at the cradle so that the electronic devices can be conveniently kept and charged.

Objectives of the present invention are not limited to the objectives mentioned above, and other unmentioned objectives will be clearly understood by one of ordinary skill in the art from the following description.

According to an aspect of the present invention, there is provided an apparatus for charging a large number of electronic devices, the apparatus including: a body that provides a predetermined internal space; a door that is configured at a front side of the body and opens/closes a front portion of the body; a cradle that is disposed in the body and provides a plurality of accommodation spaces so that electronic devices can be accommodated in the plurality of accommodation spaces; and a charging connector that is configured at the cradle so as to correspond to the plurality of accommodation spaces of the cradle, that comes into non-insertion contact with a charging port of each of the electronic devices when the electronic devices are accommodated in the accommodation spaces and that supplies charging power from a power supply unit.

The charging port may include a non-insertion type contact terminal and a magnetic coupling member.

The body may have uneven coupling grooves and uneven coupling blocks configured on a bottom end and a top end thereof, and a magnetic member or a magnetized member may be configured at the coupling grooves and the coupling blocks so that a plurality of bodies can be stacked using magnetism, and when a plurality of wheels are configured on the bottom end of the body so that the body can be conveniently moved, upper sides of the plurality of wheels may also be configured to correspond to the coupling blocks and may be coupled to the coupling grooves using magnetism.

The cradle may include: an accommodation body in which a support plate and a support wall that support a lower side of the electronic device in which the charging port is disposed, and a right side of the electronic device are formed; and a slot wall that partitions off a plurality of accommodation slots in which the electronic devices in a stood state are accommodated so that the charging port of the electronic device can be supported on the support plate of the accommodation body and that supports front and rear sides of the accommodated electronic devices.

The support plate of the accommodation body may be placed at an inner side of the door so that, when the door is opened, the accommodation slots face an opened portion of the front portion of the body.

The support plate of the accommodation body may be slantly configured to have a predetermined angle with respect to a bottom surface of the body.

The charging connector may include: a housing that is disposed on a concave surface formed on the support plate of the cradle corresponding to a portion in which the charging port of the electronic device is disposed when the electronic devices are accommodated in the accommodation slots; and a contact terminal that is configured at a contact surface of the housing and comes into non-insertion contact with a contact terminal configured at the charging port when the electronic devices are accommodated in the accommodation slots; and a magnetic coupling member that is configured at the contact surface of the housing and is coupled to the magnetic coupling member configured at the charging port when the electronic devices are accommodated in the accommodation slots, using magnetism.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an apparatus for charging a large number of electronic devices according to an exemplary embodiment of the present invention;

FIG. 2 is a perspective view illustrating a state in which a door is opened, in the apparatus for charging a large number of electronic devices illustrated in FIG. 1;

FIG. 3 is a cross-sectional view illustrating a state in which the electronic devices are kept in a cart when the door is opened, in the apparatus of FIG. 2;

FIG. 4 is a cross-sectional view illustrating a state in which the door is closed after the electronic devices are kept in the cart, in the apparatus of FIG. 3; and

FIG. 5 illustrates a contact operation of a charging connector and a charging port when the electronic devices are inserted into a cradle, in the apparatus of FIG. 3.

### DETAILED DESCRIPTION OF THE INVENTION

The present invention will now be described more fully with reference to the accompanying drawings, in which exemplary embodiments of the invention are shown.

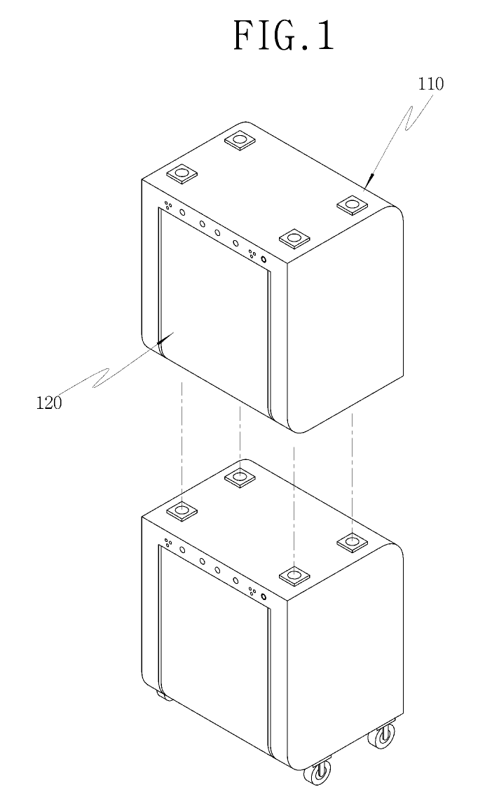

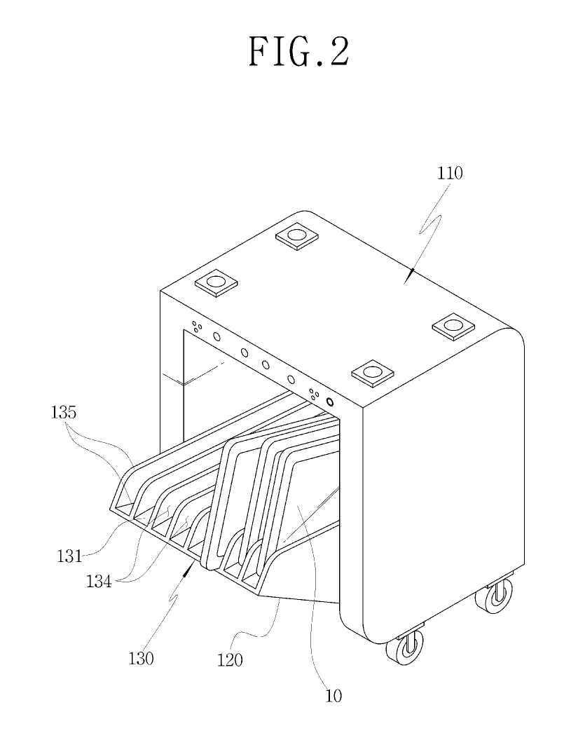

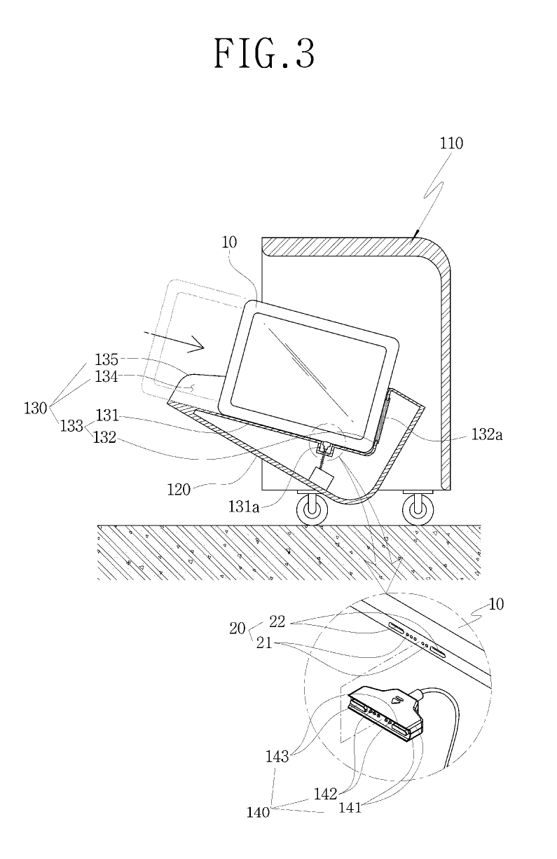

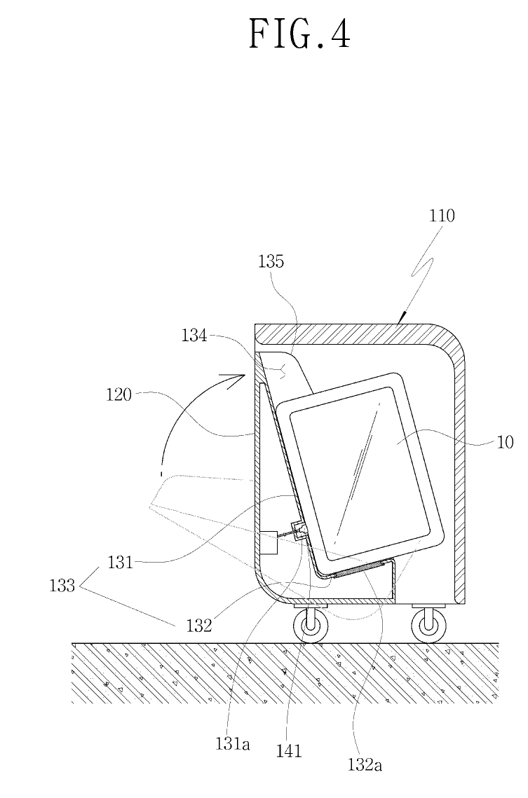

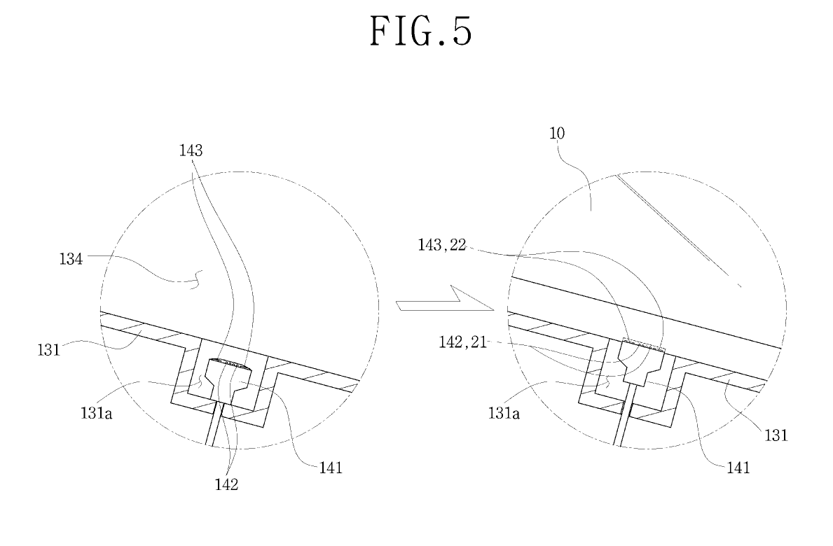

As illustrated in FIGS. 1 through 5, an apparatus for charging a large number of electronic devices according to an exemplary embodiment of the present invention includes a body 110 that provides a predetermined internal space, a door 120 that is configured at a front side of the body 110 and opens/closes a front portion of the body 110, a cradle 130 that is disposed in the body 110 and provides a plurality of accommodation spaces so that a large number of electronic devices 10 can be accommodated in the plurality of accommodation spaces, and a charging connector 140 that is configured at the cradle 130 so as to correspond to the accommodation spaces of the cradle 130, that comes into non-insertion contact with a charging port 20 of each of the electronic devices 10 when the electronic devices 10 are accommodated in the accommodation spaces and that supplies charging power from a power supply unit.

Here, the electronic devices 10 are smart devices, such as tablet personal computers (PCs), and are well-known technology and thus a detailed description thereof will be omitted.

Also, the charging port 20 is an interface unit that is configured at a right side of a lower portion of the electronic device 10 and causes operating power to be supplied and to be charged from an external power supply unit. The charging port 20 includes a non-insertion type contact terminal 21 and a magnetic coupling member 22.

The body 110 has an approximately hexahedral shape, has a predetermined space therein, and may include a plurality of wheels disposed at a bottom end thereof so that the body 110 can be conveniently moved.

The body 110 has uneven coupling grooves and uneven coupling blocks configured on a bottom end and a top end thereof, and a magnetic member or a magnetized member is configured at the coupling grooves and the coupling blocks so that a plurality of bodies can be stacked using magnetism. In this case, upper sides of the plurality of wheels may also be configured to correspond to the coupling blocks and may be simply coupled to the coupling grooves on the bottom end of the body 110 using magnetism.

Also, a power button through which the power supply unit and external common power are connected or disconnected to or from each other, and a plurality of light emitting diodes (LEDs) that display a state of electrical connection between the charging connector 140 and the charging port 20, may be configured at the body 110. When the temperature of the internal space is higher than a set temperature, ventilation and cooling units that discharge the internal air to the outside may be further configured at the body 110.

The door 120 is configured at the front side of the body 110 and opens/closes the front portion of the body 110 in a vertical direction. Through a press to open structure formed at the front side of the body 110, the door 120 causes a locked state of an upper side of the front portion of the body 110 to be released when a top end of the door 120 is pressed, and simultaneously causes a bottom end of the door 120 connected to a pivoting unit of a lower side of the front portion of the body 110 to be pivoted at a predetermined angle so that the front portion of the body 110 can be opened in the vertical direction and can be closed when a reverse operation is performed.

The cradle 130 is an accommodation unit that is disposed in the body 110 and provides a plurality of accommodation spaces so that a large number of electronic devices 10 can be accommodated in the plurality of accommodation spaces. The cradle 130 includes an accommodation body 133 in which a support plate 131 and a support wall 132 that support a lower side of the electronic device 10 in which the charging port 20 is disposed, and a right side of the electronic device 10 are formed to have an L-shaped cross-section, and a slot wall 135 that partitions off a plurality of accommodation slots 134 in which the electronic devices 10 in a stood state are accommodated so that the charging port 20 of the electronic device 10 can be supported on the support plate 131 of the accommodation body 133 and that supports front and rear sides of the electronic devices 10 accommodated in the stood state.

The accommodation body 133 may be configured in an internal space of the body 110. More preferably, the accommodation body 133 may be configured so that the support plate 131 can be disposed at an inner side of the door 120, and when the door 120 is opened, the accommodation slots 134 may face an opened portion of the front portion of the body 110.

The slot wall 135 may be configured at a separation distance that corresponds to a height from a lower side in which the charging port 20 of the electronic devices 10 is disposed, to a middle portion and to a thickness of the electronic device 10 so that, when the electronic devices 10 are accommodated in the accommodation slots 134, the electronic devices 10 can be prevented from being inclined toward a front side or a rear side of the body 110.

A shock prevention pad 132a may be configured at the support wall 132 so as to prevent shock from being transferred to right sides of the electronic devices 10 when the electronic devices 10 are inserted into the accommodation slots 134.

When the support plate 131 of the accommodation body 133 of the cradle 130 is configured on a bottom surface of the body 110 or at the door 120, the support plate 131 of the accommodation body 133 is configured to have a predetermined angle with respect to an inner side of the door 120. Thus, when the door 120 is opened, the electronic devices 10 in the stood state may slantly slide in the accommodation slots 134 and may be inserted into the accommodation slots 134 so that an accommodation work can be conveniently performed.

Also, if the support plate 131 of the cradle 130 is configured at the inner side of the door 120 to have a predetermined angle, as described above, when the door 120 is closed, the lower side of the electronic device 10, i.e., a portion in which the charging port 20 is disposed, and a right portion of the electronic device 10 are kept to have a predetermined slope in a state in which they are supported on the support plate 131 and the support wall 132, so that contact between the charging connector 140 and the charging port 20 can be stabilized without being spaced apart or separated from each other.

The charging connector 140 is an interface unit that is configured to correspond to the accommodation slots 134 of the cradle 130, comes into non-insertion contact with the charging port 20 of the electronic device 10 when the electronic devices 10 are accommodated and that supplies charging power from the power supply unit. The charging connector 140 includes a housing 141 that is disposed on a concave surface 131a formed on the support plate 131 of the accommodation body 133 of the cradle 130 that corresponds to a portion in which the charging port 20 of the electronic device 10 is disposed when the electronic devices 10 are accommodated in the accommodation slots 134, a contact terminal 142 that is configured at a contact surface of the housing 141 and comes into non-insertion contact with a contact terminal 21 configured at the charging port 20 of the electronic device 10 when the electronic devices 10 are accommodated in the accommodation slots 134, thereby enabling supply of power, and a magnetic coupling member 143 that is configured at the contact surface of the housing 141, is coupled to a magnetic coupling member 22 configured at the charging port 20 of the electronic device 10 when the electronic devices 10 are accommodated in the accommodation slots 134, using magnetism and that enables a stable contact state between the contact terminals 142 and 21.

When the electronic devices 10 are accommodated in the accommodation slots 134 in a state in which the housing 141 is disposed in the concave surface 131a of the support plate 131, if the magnetic coupling member 143 is coupled to the magnetic coupling member 22 of the charging port 20 using magnetism, the housing 141 rises toward an opening of the concave surface 131a, and if the magnetic coupling member 143 is not coupled to the magnetic coupling member 22 of the charging port 20 using magnetism, the housing 141 falls toward a lower part of the opening of the concave surface 131a, i.e., the housing 141 enters an upper opening of the concave surface 131a depending on whether magnetic coupling is performed or not.

That is, the housing 141 is configured not to be an obstacle at the lower side of the electronic device 10 that slides so as to be accommodated in the accommodation slots 134 or to release accommodation of the electronic devices 10 in the accommodation slots 134 and enables non-insertion contact between the charging port 20 and the charging connector 140 using magnetism when the electronic devices 10 are accommodated in the accommodation slots 134 and enables releasing magnetic coupling of the charging port 20 and the charging connector 140 when accommodation of the electronic devices 10 is released.

Here, the housing 141 has a hexahedral shape in which a front case and a rear case of the housing 141 are coupled to each other. The front case of the housing 141 surrounds a contact surface of the charging port 20 when contacting the charging port 20 for charging or data communication, using a curvature portion in which upper and lower sides of the contact surface contacting the charging port 20 of the electronic device 10 extend to a predetermined length and a predetermined curvature, so that, even when external force having a predetermined size is generated, a stable contact state therebetween can be maintained.

A mounting block that is a mounting member is configured in the housing 141. The contact terminal 142 and the magnetic coupling member 143 are accommodated and configured at positions of the mounting block. Thus, even when the housing 141 has a small size, the contact terminal 142 and the magnetic coupling member 143 can be easily configured and assembled.

The contact terminal 142 is connected to and mounted on a printed circuit board (PCB) in a state in which the contact terminal 142 is provided at an inner side of one surface of the mounting block, and an end of the contact terminal 142 is exposed to an outer side of the front case of the housing 141.

Here, the number of contact terminals 142 that corresponds to the number of contact terminals 21 configured at the charging port 20 of the electronic device 10, may be disposed. Also, the contact terminal 142 may include a planar terminal, of which an end has a planar or concave surface and an elastic terminal, of which an end has elasticity of a spring provided inside the contact terminal 142, which rebounds toward the PCB and is inserted into the PCB or only the end bends toward the PCB with elasticity. In this case, the planar terminal has a structure in which a terminal is recessed into a through hole formed in the contact surface or a structure that corresponds to a planar surface of the through hole, and the elastic terminal has a structure in which part of a terminal protrudes toward an outer side of the through hole formed in the contact surface.

That is, the contact terminal 142 may be configured as the elastic terminal when the contact terminal 21 of the charging port 20 is a planar terminal, and the contract terminal may be configured as the planar terminal when the contact terminal 21 of the charging port 20 is an elastic terminal.

Also, charging power may be supplied to the PCB on which the contact terminal 42 is mounted, from the power supply unit.

The magnetic coupling member 143 is disposed on the mounting block in which the contact terminal 142 is configured, so as to correspond to the magnetic coupling member 22 of the charging port 20. When the magnetic coupling member 143 is configured as a magnetic member, the magnetic coupling member 143 may be at least one selected from the group consisting of a magnet, an electromagnet, a permanent magnet, a monopole magnetizer, and a multi-pole magnetizer. When the magnetic coupling member 143 is a magnetized member, the magnetic coupling member 143 may include metals or ferromagnetic substances that may be coupled to the magnetic member using magnetism.

That is, the magnetic coupling member 143 may be a magnetic member or a magnetized member when the magnetic coupling member 22 of the charging port 20 is a magnetic member, and the magnetic coupling member 143 may be a magnetic member when the magnetic coupling member 22 of the charging port 20 is a magnetized member.

Here, when the magnetic coupling member 143 is a magnet, the magnetic coupling member 143 is manufactured as vertical monopole, two-pole and four-pole magnetizers using equipment called a ‘magnetizing yoke’ without physically dividing the magnet so as to have various numbers of polarities, or a back plate may be placed at at least one selected from a rear side, right and left sides, and upper and lower sides of the magnet so that magnetism can be improved using securing linearity of magnetism, or when magnets are coupled to each other using magnetism, only corresponding polarities of the magnets are coupled so that, when the charging port 20 and the charging connector 140 need to come into contact with each other with directivity, contact in a reverse direction can also be prevented.

Meanwhile, a short prevention portion is further configured at the PCB. The short prevention portion may include a voltage short prevention circuit in which the non-insertion type contact terminal 142 is shorted by an external conductive material and blocks a current provided to the charging port 20 of the electronic device 10 when a short occurs in power supply lines of V-BUS and GND.

A guide unit (not shown) that enables non-insertion contact between contact terminals using magnetic coupling of the magnetic coupling members may be further configured at the contact surface of the housing 141 of the charging connector 140 and the contact surface of the charging port 20. Insertion in a reverse direction can also be prevented using the guide unit.

Here, the guide unit may be formed as one of an embossed guide that protrudes from the contact surface to surround edges of the contact surface and an intagliated guide that is recessed into the contact surface.

That is, when a guide unit of the charging port 20 is an intagliated guide, the guide unit of the charging connector 140 may be configured as an embossed guide, and when a guide unit of the charging port 20 is an embossed guide, the guide unit of the charging connector 140 may be an intagliated guide.

Thus, according to the charging connector 140, when the electronic devices 10 slide in and are accommodated in the accommodation slots 134 and the charging port 20 of the electronic device 10 is placed on the concave surface 131a formed in the accommodation slots 134, the magnetic coupling member 142 configured at the housing 141 is coupled to the magnetic coupling member 22 of the charging port 20 using magnetism, and the housing 141 rises toward the upper opening of the concave surface 131a. In this case, the contact terminal 142 configured at the housing 141 comes into non-insertion contact with the contact terminal 21 of the charging port 20 so that operating power or charging power can be supplied to the charging port 20.

Here, according to the charging connector 140, when accommodation of the electronic devices 10 is forcibly released from the accommodation slots 134, magnetic coupling of the magnetic coupling members is forcibly released. In this case, the housing 141 falls and is moved to an internal space of the concave surface 131a.

Hereinafter, keeping and charging a large number of electronic devices using the apparatus for charging a large number of electronic devices according to the exemplary embodiment of the present invention will be described.

First, when an upper side of the door 120 configured to have a press to open structure is pressurized toward the body 110, the body 110 is opened according to an operation of the door 120 that is pivoted in a vertical direction to have a predetermined angle from the front portion of the body 110.

In this case, the cradle 130 is configured at the inner side of the door 120, and the cradle 130 includes the accommodation body 133 having the support plate 131 and the support wall 132 in which the accommodation slots 134 in which a plurality of electronic devices 10 can be accommodated.

Subsequently, in a state in which the electronic devices 10 are stood by an operator or a manager, i.e., in a state in which the lower side of the electronic device 10 in which the charging port 20 is placed, is disposed on the support plate 131 of the accommodation body 133 and the right side of the electronic device 10 is disposed on the support wall 132 of the accommodation body 133, the electronic devices 10 slide in and are accommodated in the accommodation slots 134.

Here, when the support plate 131 is configured on the bottom surface of the body 110 or at the door 120, the cradle 130 is configured to have a predetermined angle with respect to the inner side of the door 120. When the door 120 is opened, the electronic devices 10 in a stood state slantly slide in and are inserted into the accommodation slots 134 so that an accommodation work can be conveniently performed.

Subsequently, when sliding accommodation of the electronic devices 10 in the accommodation slots 134 is completed, as described above, the charging port 20 of the electronic device 10 is placed on the concave surface 131a of the support plate 131.

In this case, the charging connector 140 placed on the concave surface 131a of the support plate 131 includes the housing 141 which is configured to enter the internal space of the concave surface 131a and in which the contact terminal 142 and the magnetic coupling member 143 are configured at the contact surface contacting the charging port 20 of the electronic device 10.

Thus, when the magnetic coupling member 142 configured at the housing 141 is coupled to the magnetic coupling member 22 of the charging port 20 using magnetism, the housing 141 rises toward the upper opening of the concave surface 131a. In this case, the contact terminal 142 configured at the housing 141 comes into non-insertion contact with the contact terminal 21 of the charging port 20 so that operating power or charging power can be supplied to the charging port 20.

Subsequently, after the body 110 is closed according to an operation in which the door 120 is pivoted in the vertical direction, when signals are applied to the power button configured at the body 110, as charging and operating power are supplied from the power supply unit connected to the housing 141 using an electric wire, charging of the electronic devices 10 is performed. In this case, signals corresponding to the charging operation of the housing 141 are displayed on the LEDs of the body 110 so that the operator or manager can check a state of electrical connection between the charging connector 140 and the charging port 20 configured at the electronic device 10.

Thus, according to the present invention described above, when the electronic devices 10 are kept in the cradle 130 of the apparatus for charging a large number of electronic devices, the charging port 20 of the electronic device 10 comes into non-insertion contact with the charging connector 140 configured at the cradle 130 so that the electronic devices 10 can be conveniently kept and charged.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for charging a large number of electronic devices, the apparatus comprising:
a body that provides a predetermined internal space;
a door that is configured at a front side of the body and opens/closes a front portion of the body;
a cradle that is disposed in the body and provides a plurality of accommodation spaces so that electronic devices can be accommodated in the plurality of accommodation spaces; and
a charging connector that is configured at the cradle so as to correspond to the plurality of accommodation spaces of the cradle, that comes into non-insertion contact with a charging port of each of the electronic devices when the electronic devices are accommodated in the accommodation spaces and that supplies charging power from a power supply unit.

2. The apparatus of claim 1, wherein the charging port comprises a non-insertion type contact terminal and a magnetic coupling member.

3. The apparatus of claim 1, wherein the body has uneven coupling grooves and uneven coupling blocks configured on a bottom end and a top end thereof, and a magnetic member or a magnetized member is configured at the coupling grooves and the coupling blocks so that a plurality of bodies can be stacked using magnetism, and
when a plurality of wheels are configured on the bottom end of the body so that the body can be conveniently moved, upper sides of the plurality of wheels are also configured to correspond to the coupling blocks and are coupled to the coupling grooves using magnetism.

4. The apparatus of claim 2, wherein the cradle comprises:
an accommodation body in which a support plate and a support wall that support a lower side of the electronic device in which the charging port is disposed, and a right side of the electronic device are formed; and
a slot wall that partitions off a plurality of accommodation slots in which the electronic devices in a stood state are accommodated so that the charging port of the electronic device can be supported on the support plate of the accommodation body and that supports front and rear sides of the accommodated electronic devices.

5. The apparatus of claim 4, wherein the support plate of the accommodation body is placed at an inner side of the door so that, when the door is opened, the accommodation slots face an opened portion of the front portion of the body.

6. The apparatus of claim 4, wherein the support plate of the accommodation body is slantly configured to have a predetermined angle with respect to a bottom surface of the body.

7. The apparatus of claim 4, wherein the charging connector comprises:
a housing that is disposed on a concave surface formed on the support plate of the cradle corresponding to a portion in which the charging port of the electronic device is disposed when the electronic devices are accommodated in the accommodation slots; and
a contact terminal that is configured at a contact surface of the housing and comes into non-insertion contact with a contact terminal configured at the charging port when the electronic devices are accommodated in the accommodation slots; and
a magnetic coupling member that is configured at the contact surface of the housing and is coupled to the magnetic coupling member configured at the charging port when the electronic devices are accommodated in the accommodation slots, using magnetism.

8. The apparatus of claim 7, wherein the housing is configured to enter an opening of the concave surface depending on whether the magnetic coupling member and the magnetic coupling member of the charging port are coupled to each other using magnetism in a state in which the housing is disposed on the concave surface of the support plate.

9. The apparatus of claim 7, wherein the housing has a curvature portion in which upper and lower sides of the contact surface contacting the charging port of the electronic device extend to a predetermined length and a predetermined curvature.

10. The apparatus of claim 7, wherein the contact terminal is an elastic terminal, of which an end is exposed to an outer side of the contact surface of the housing.

11. The apparatus of claim 7, wherein the magnetic coupling member is a magnetic member configured at the contact surface of the housing.
